(19) United States
(12) Patent Application Publication
(10) Pub. No.: US 2014/0251140 A1
(43) Pub. Date: Sep. 11, 2014

(54) Methods To Reduce Gas Carry-Under For Cyclonic Separators

(71) Applicant: Cameron Solutions, Inc., Houston, TX (US)

(72) Inventors: Gary W. Sams, Spring, TX (US); Joseph Min-Hsiun Lee, Houston, TX (US)

(73) Assignee: Cameron Solutions, Inc., Houston, TX (US)

(21) Appl. No.: 14/197,747

(22) Filed: Mar. 5, 2014

Related U.S. Application Data
(60) Provisional application No. 61/773,362, filed on Mar. 6, 2013.

(51) Int. Cl. B04C 3/00

(52) U.S. Cl. CPC B04C 3/00; B04C 2003/006
USPC 95/261; 96/216; 96/215

(57) ABSTRACT

A system and process for an improvement to a gas-liquid cylindrical cyclone (“GLCC”) separator to reduce gas carry-under to the liquid outlet of the separator is described. The means for reducing gas carry-under is arranged within the interior space of the separator and below the inclined inlet of the separator to affect the tangential flow of the incoming liquid-and-gas mixture stream into the interior space. The reducing means may be a vortex locator, preferably in the form of a horizontal plate, arranged coaxial with the separator vessel and located at a vortex formation point within the interior space. The reducing means may also be a plurality of vertical baffles located at a lower end of the separator vessel and extending radially inward from the wall of the vessel. The reducing means may also be a combination of the horizontal plate and vertical baffles.

### CROSS-REFERENCE To RELATED APPLICATIONS

The present application claims priority to U.S. Provisional Patent Application No. 61/773,362 filed on Mar. 6, 2013, which is incorporated herein by reference.

### BACKGROUND OF THE INVENTION

This invention relates generally to systems, apparatuses, and methods for separating gas from liquid. More specifically, the invention relates to improvements in gas-liquid cylindrical cyclone (“GLCC”) separators used in the oil-and-gas industry.

As shown in FIG. 1, prior art GLCC separators include a cylindrical body having a gas outlet at its upper end, a liquid outlet at its lower end, and an inclined gas-and-liquid inlet located between the gas outlet and the liquid outlet. The inclined inlet creates a tangential flow to the interior of the cylindrical body that causes the liquid-and-gas mixture stream to swirl within the body. Liquid is forced radially outward toward the walls of the body and downward to the liquid outlet. Some gas, in a range of up to five percent of the total gas volume, is “carried under” with the liquid.

Additional information on the performance of prior art GLCC separators can be found in the following two references, each of which is hereby incorporated by reference: Eduardo J. Pereyra, Modeling of integrated compact multiphase separation system (CMSS) (Dissertation, Univ. Tulsa 2011) and B. Aminnejad, Modeling of a 1-inch diameter air-water cylindrical hydrocyclone (Dissertation, Daihousie Univ. 2004).

Reducing the amount of gas carry-under has benefits, including improving the separation efficiency of the GLCC separator and the performance of downstream processing equipment such as electrostatic crude dehydration equipment.

### SUMMARY OF THE INVENTION

An improvement to a GLCC separator has means for reducing gas carry-under to a liquid outlet of the separator. The reducing means is arranged within an interior space of the separator and below an inclined inlet of the separator to affect the tangential flow of the incoming liquid-and-gas mixture stream into the interior space.

In one embodiment, the reducing means is a vortex locator, preferably in the form of a horizontal plate, arranged coaxial with the separator vessel and located at a vortex formation point within the interior space. In another embodiment, the reducing means is a plurality of vertical baffles located at a lower end of the separator and extending radially inward from the wall of the separator. In still another embodiment, the plate and vertical baffles are used in combination with one another.

Objects of this invention include providing means within an interior space of a GLCC separator that (1) affects the formation of a vortex in the incoming, tangentially flowing liquid-and-gas mixture stream; (2) reduces the amount of gas carry-under to the liquid outlet; (3) improves the separation efficiency of the GLCC separator; and (4) enhances the performance of downstream processing equipment.

### BRIEF DESCRIPTION OF THE DRAWINGS

FIG. 1 is an isometric view of a GLCC separator used in the oil and gas industry, according to the prior art.

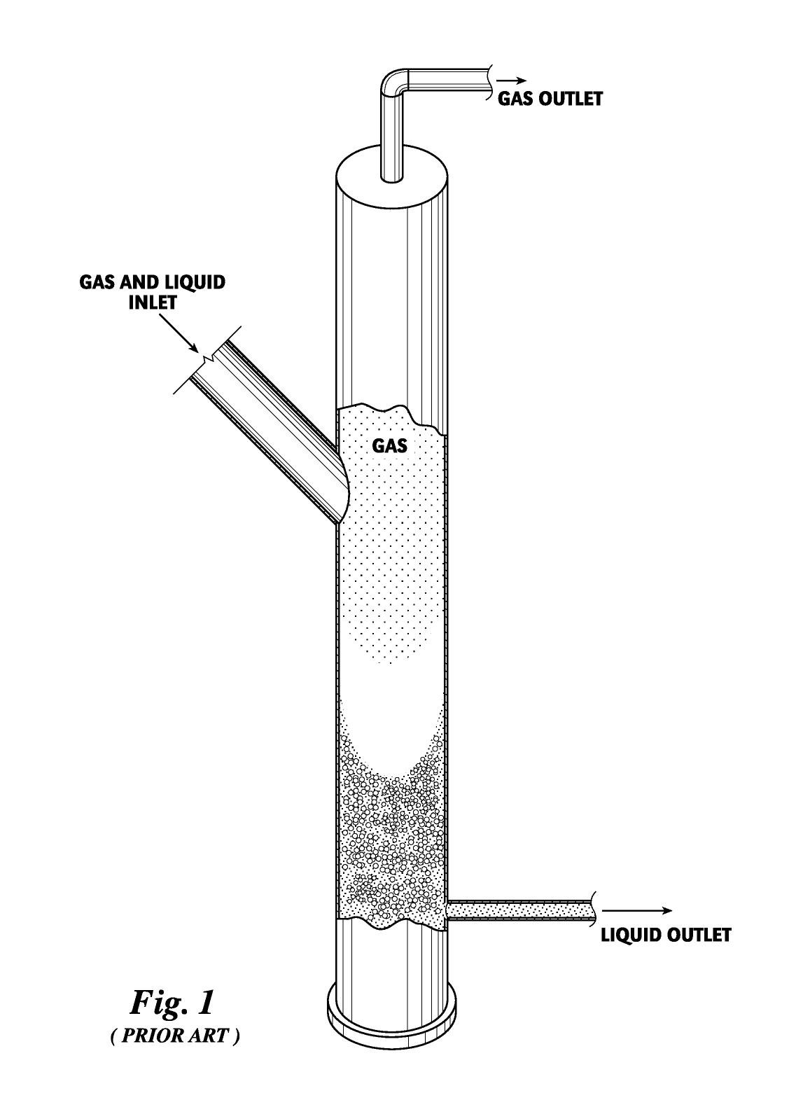

FIG. 2 is an isometric view of a preferred embodiment of a GLCC separator made according to this invention and showing the vortex locator in the form of a horizontal plate.

FIG. 3 is an isometric view of another preferred embodiment of a GLCC separator made according to this invention and showing the baffle arrangement at the lower end of the vessel of the separator.

FIG. 4 is an isometric view of another preferred embodiment of a GLCC separator made according to this invention and showing the vortex locator used in combination with the baffle arrangement.

### ELEMENTS AND NUMBERING USED IN THE DRAWINGS

10 Gas-liquid cylindrical cyclonic (“GLCC”) separator
11 Cylindrical body or vessel
13 Gas-liquid inlet
15 Liquid outlet
17 Lower end
19 Gas outlet
21 Upper end
23 Wall
30 Vortex locator
31 Plate
33 Support arms
40 Baffle arrangement
41 Vertical baffle

### DETAILED DESCRIPTION OF THE PREFERRED EMBODIMENTS

A gas-liquid cylindrical cyclone (“GLCC”) separator made according to this invention reduces gas carry-under by including a vortex locator, a baffle arrangement, or both a vortex locator and a baffle arrangement within the interior space of the GLCC separator 10.

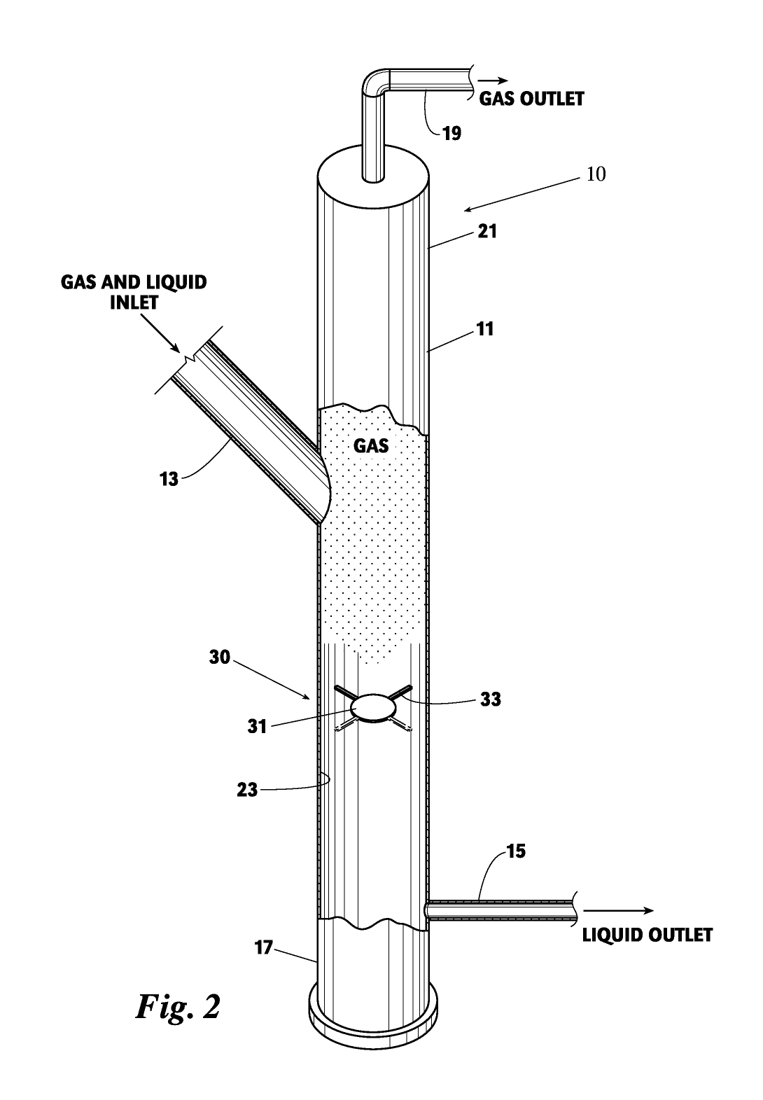

Referring first to FIG. 2, the GLCC separator 10 includes a cylindrical body or vessel 11 having a liquid outlet 15 located at a lower end 17 of the vessel 11, a gas outlet 19 located at an upper end 21 of the vessel 11, and an inclined gas-liquid inlet 13 located between the liquid outlet 15 and the gas outlet 19. A vortex locator 30 provides a location that supports the tail of the vortex formed by the incoming tangential or cyclonic flow of the liquid-and-gas mixture stream, thereby reducing the amount of gas carry-under in the liquid outlet 15.

The vortex locator 30, preferably in the form of a plate 31, is arranged coaxial with the vessel 11, horizontally within the interior space of the vessel 11, and below the gas-liquid inlet 13 but above the liquid outlet 15 at the point at which a vortex will form within the interior space of the vessel 11. The diameter of the plate 31 is preferably in a range of about 0.25 to 0.86 of the diameter of vessel 11. The plate 31 is held in place by a series of support arms 33 which are welded to the plate 31 and the wall 23 of the vessel 11.

The vortex formation point is a function of multiple factors, including but not limited to the incline of the gas-liquid inlet 13, the size of the vessel 11, the volume of the liquid-and-gas mixture stream exiting the inlet 13 into the interior of the vessel 11, the viscosity of that mixture stream, and the relative proportion of gas and liquid in the mixture stream. This point can be calculated or determined empirically through routine experimentation.

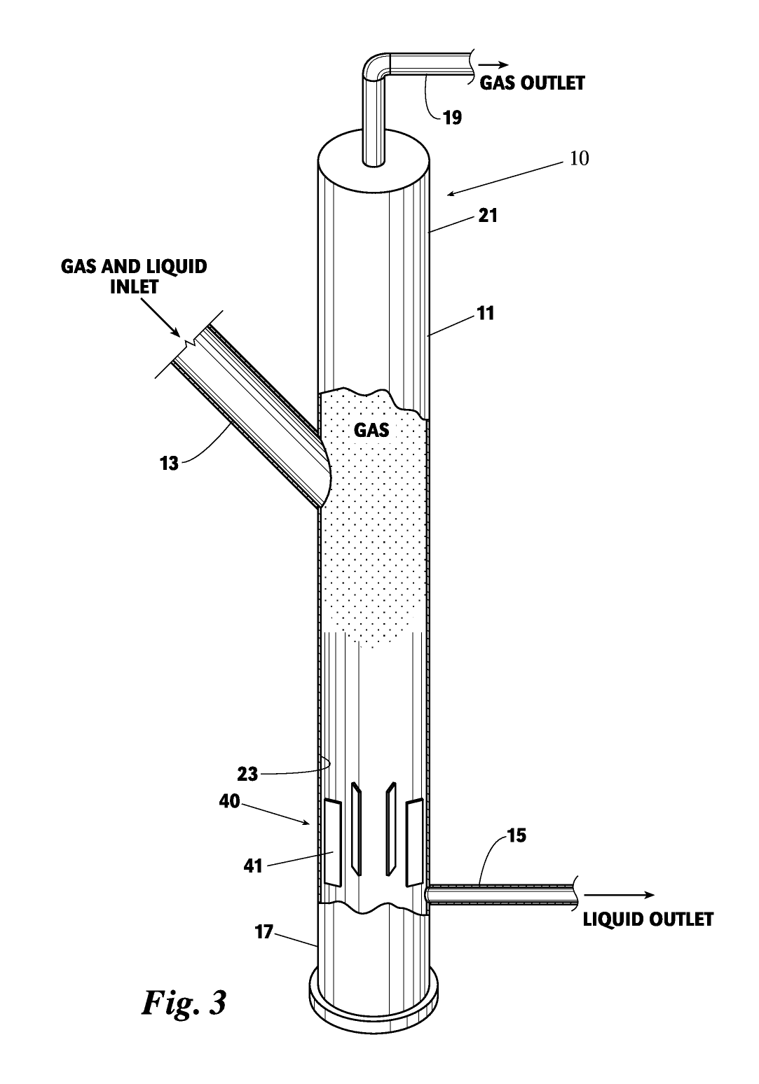

Referring to FIG. 3, the GLLC separator 10 includes a cylindrical body or vessel 11 having a liquid outlet 15 located at a lower end 17 of the vessel 11, a gas outlet 19 located at an upper end 21 of the vessel 11, and an inclined gas-liquid inlet 13 located between the liquid outlet 15 and the gas outlet 19. The GLCC separator 10 also includes a baffle arrangement 40, located at the lower end 17 of the vessel 11, that eliminates or reduces the swirling flow of the liquid-and-gas mixture stream, thereby preventing gas being carried into the liquid outlet 15. The baffle arrangement 40 is preferably a series of vertical baffles 41 that protrude radially inward but are separated from the wall 23 of the vessel 11. The number of vertical baffles 41 depends, in part, on the vessel diameter. The height of each vertical baffle 41 is about 1.5 the diameter of the vessel 11, while the width of each vertical baffle 41 is about twenty percent of the diameter of the vessel 11. The vertical baffles 41 are placed within the vessel 11 so that the lower ends of the vertical baffles 41 are above the liquid outlet 15.

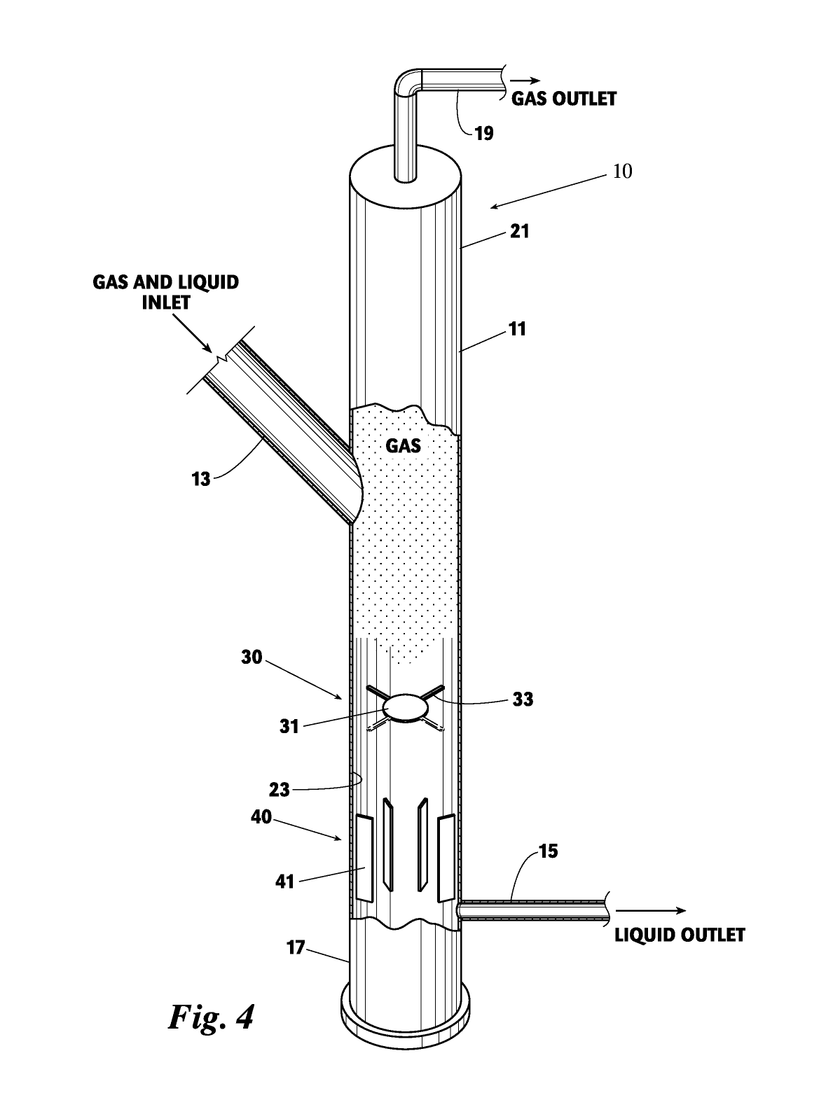

Referring to FIG. 4, the GLLC separator 10 includes a cylindrical body or vessel 11 having a liquid outlet 15 located at a lower end 17 of the vessel 11, a gas outlet 19 located at an upper end 21 of the vessel 11, and an inclined gas-liquid inlet 13 located between the liquid outlet 15 and the gas outlet 19. The GLCC separator 10 also includes a vortex locator 30, which provides a location that supports the tail of the vortex formed by the tangential or cyclonic flow of the incoming liquid-and-gas mixture stream, in combination with a baffle arrangement 40, which prevents gas being carried into the liquid outlet 15 by eliminating or reducing the swirling flow of the liquid-and-gas mixture stream.

The vortex locator 30, preferably in the form of a plate 31, is arranged coaxial with the vessel 11, horizontally within the interior space of the vessel 11, and below the gas-liquid inlet 13 but above the liquid outlet 15 at the point at which a vortex will form within the interior space of the vessel 11. The diameter of the plate 31 is preferably in a range of about 0.25 to 0.86 of the diameter of vessel 11. The plate 31 is held in place by a series of support arms 33 which are welded to the plate 31 and the wall 23 of the vessel 11.

The baffle arrangement is located at the lower end 17 of the vessel 11 and is preferably a series of vertical baffles 41 that protrude radially inward but are separated from the wall 23 of the vessel 11. The number of vertical baffles 41 depends, in part, on the vessel diameter. The baffle arrangement 40 is located below the vortex locator 30.

An advantage of the present invention is that it controls the formation of a vortex in the tangential or cyclonic flow of the incoming liquid-and-gas mixture stream. Another advantage of the present invention is that it eliminates or reduces the swirling flow of the liquid-and-gas mixture stream, thereby preventing gas being carried into the liquid outlet of the GLCC separator. Other advantages of the present invention include improving the separation efficiency of the GLCC separator and enhancing the performance of downstream treatment processes. Further, while the embodiments have been described for GLCC separators in the oil-and-gas industry, they are equally applicable to other cyclonic-type separators and to other industries where separation of a mixed gas-and-liquid stream into its individual components is necessary or beneficial.

While preferred embodiments of a system and process for reducing gas carry-under for cyclonic-type separators have been described in detail, a person of ordinary skill in the art understands that certain changes can be made in the arrangement of process steps and type of components used in the system and process without departing from the scope of the following claims.

What is claimed:

1. An improvement to a gas-liquid cylindrical cyclone (“GLCC”) separator vessel, the improvement comprising:
means for reducing gas carry-under to a liquid outlet of the vessel, wherein the reducing means is arranged within an interior space of the vessel and below an inclined inlet of the vessel to affect a tangential flow of an incoming liquid-and-gas mixture stream into the interior space.

2. An improvement according to claim 1 wherein the reducing means is located at a vortex formation point within the interior space.

3. An improvement according to claim 2 wherein the reducing means is a horizontal plate arranged coaxial with the vessel.

4. An improvement according to claim 3 wherein the horizontal plate has a dimension in a range of 0.25 to 0.86 of a diameter of the vessel.

5. An improvement according to claim 3 wherein the horizontal plate is held in place by a plurality of support arms that are welded to the horizontal plate and to a wall of the vessel.

6. An improvement according to claim 1 wherein the reducing means is a plurality of vertical baffles located at a lower end of the vessel and extending radially inward from a wall of the vessel.

7. An improvement according to claim 6 wherein the vertical baffles have a height that is about 1.5 times a diameter of the vessel.

8. An improvement according to claim 6 wherein the vertical baffles have a width that is about 20 percent of a diameter of the vessel.

9. An improvement according to claim 6 wherein lower ends of the vertical baffles are located above a liquid outlet of the vessel.

10. An improvement according to claim 1 wherein the reducing means is a combination of a horizontal plate arranged coaxial with the vessel at a vortex formation point within the interior space and a plurality of vertical baffles located at a lower end of the vessel and extending radially inward from a wall of the vessel.

11. An improvement according to claim 10 wherein the plurality of vertical baffles is located below the horizontal plate.

12. A process for reducing gas carry-under in a GLCC separator vessel, the process comprising the step of:
passing a liquid-and-gas mixture stream through a means for reducing gas carry-under to a liquid outlet of the vessel,
wherein the reducing means is arranged within an interior space of the vessel and below an inclined inlet of the vessel to affect a tangential flow of an incoming liquid-and-gas mixture stream into the interior space.

13. A process according to claim 12 wherein the reducing means is chosen from the group consisting of a vortex locator located at a vortex formation point within the interior space, a plurality of vertical baffles located at a lower end of the vessel and extending radially inward, and a combination of a vortex locator and a plurality of vertical baffles.
